(19) United States
(12) Patent Application Publication
(10) Pub. No.: US 2025/0303966 A1
(43) Pub. Date: Oct. 2, 2025

(54) VEHICLE DISPLAY SYSTEM

(71) Applicant: FCA US LLC, Auburn Hills, MI (US)

(72) Inventor: James A. Robertson, White Lake, MI (US)

(21) Appl. No.: 18/619,567

(22) Filed: Mar. 28, 2024

(51) Int. Cl. B60R 1/28; G06T 7/70; H04N 23/90

(52) U.S. Cl. CPC B60R 1/28; G06T 7/70; H04N 23/90; B60R 2300/105; B60R 2300/202; G06T 2207/30196; G06T 2207/30268

(57) ABSTRACT

A vehicle display system, includes at least one camera having at least one captured field of view that extends at least partially outward from an exterior of a vehicle, a display mounted on a pillar within an interior of the vehicle, and a controller coupled to the camera and the display to show a displayed field of view on the display. The displayed field of view is at least part of the at least one captured field of view and wherein the controller is configured to provide more than one displayed field of view concurrently from the at least one camera to the display.

### FIELD

The present disclosure relates to a vehicle system for displaying images, video and/or other data within the interior of the vehicle.

### BACKGROUND

Vehicles often have pillars containing structural members to support a vehicle body and other various components. These pillars often obstruct a substantial portion of a vehicle occupant's field of view. This can create problems for a vehicle occupant/operator as areas outboard of the pillars may be obscured from view by one or more of the pillars. Additionally, vehicles typically have mirrors mounted to and extending outwardly from the sides of the vehicle, and oriented facing rearwardly. Such rearview side mirrors provide a field of view that can reduce blind spots but in doing so they create resistance to airflow that reduces energy efficiency of the vehicle, and such mirrors might not be aesthetically pleasing to some people.

### SUMMARY

In at least some implementations, a vehicle display system, includes at least one camera having at least one captured field of view that extends at least partially outward from an exterior of a vehicle, a display mounted on a pillar within an interior of the vehicle, and a controller coupled to the camera and the display to show a displayed field of view on the display. The displayed field of view is at least part of the at least one captured field of view and wherein the controller is configured to provide more than one displayed field of view concurrently from the at least one camera to the display.

In at least some implementations, the controller and display are configured to show multiple displayed fields of view from the at least one camera concurrently on separate portions of the display. In at least some implementations, the at least one captured field of view includes a first captured field of view extending outward from the pillar and a second captured field of view extending towards the rear of the vehicle that includes at least a portion of an area outward of a side of the vehicle. In at least some implementations, the first displayed field of view and second displayed field of view are shown concurrently on separate portions of the display. In at least some implementations, the orientation of the first displayed field of view and the second displayed field of view on the display is configurable by a vehicle occupant.

In at least some implementations, the at least one camera includes a first camera having a first captured field of view extending outward from the pillar and a second camera having a second captured field of view extending towards the rear of the vehicle that includes at least a portion of an area outward of a side of the vehicle. In at least some implementations, at least parts of the first captured field of view and the second captured field of view are shown concurrently on separate portions of the display. In at least some implementations, the orientation of the at least parts of the first captured field of view and the second captured field of view on the display is configurable by a vehicle occupant.

In at least some implementations, a vehicle system includes a camera having a first captured field of view that extends at least partially outward from an exterior of a vehicle, a display mounted on a pillar within an interior of the vehicle, and a controller coupled to the camera and the display to a first displayed field of view on the display The first displayed field of view is at least part of the first captured field of view and the first displayed field of view is adjusted as a function of a viewing angle.

In at least some implementations, the vehicle includes a seat, and the viewing angle is determined as a function of a position of the seat of the vehicle. In at least some implementations, the viewing angle considers the position of the seat relative to the pillar to approximate the position of a vehicle occupant. In at least some implementations, the controller adjusts the output from the camera based on the approximated position of the vehicle occupant such that a portion of a vehicle occupant field of view that is obscured by the pillar is shown on the display.

In at least some implementations, a second camera is coupled to the controller and the display, and the second camera has a second captured field of view wherein the controller is configured to show on the display a second displayed field of view that includes at least part of the second captured field of view. In at least some implementations, the first displayed field of view and second displayed field of view are shown concurrently on separate portions of the display. In at least some implementations, the orientation of the first displayed field of view and the second displayed field of view on the display is configurable by a vehicle occupant.

In at least some implementations, an interior camera is provided facing the interior of the vehicle, and the interior camera is configured to detect a position of at least part of a vehicle occupant relative to the pillar. In at least some implementations, the viewing angle is determined as a function of the position of the vehicle occupant relative to the pillar. In at least some implementations, the controller adjusts the first displayed field of view to include an area that is outboard of the pillar relative to the occupant and the viewing angle, wherein the area that is outboard of the pillar is obscured by the pillar from direct viewing by the occupant.

In at least some implementations, a second camera has a second captured field of view and a second displayed field of view wherein the first displayed field of view and the second displayed field of view are shown concurrently on separate portions of the display. In at least some implementations, the orientation of the first displayed field of view and the second displayed field of view on the display is configurable by a vehicle occupant.

### BRIEF DESCRIPTION OF THE DRAWINGS

FIG. 1 is a top view of a vehicle having one camera and showing a captured field of view of the camera;

FIG. 2 is a top view of a vehicle having two cameras and showing the captured field of view of each camera;

FIG. 3 is a perspective view of part of an interior of the vehicle facing an A-pillar of the vehicle;

FIG. 4 is a diagrammatic top view of part of the vehicle interior including a display on part of the A-pillar and showing an embodiment where viewing angle is adjusted as a function of an interior camera's output; and

FIG. 5 is a view similar to FIG. 4 and showing an embodiment where viewing angle is adjusted as a function of seat position.

### DETAILED DESCRIPTION

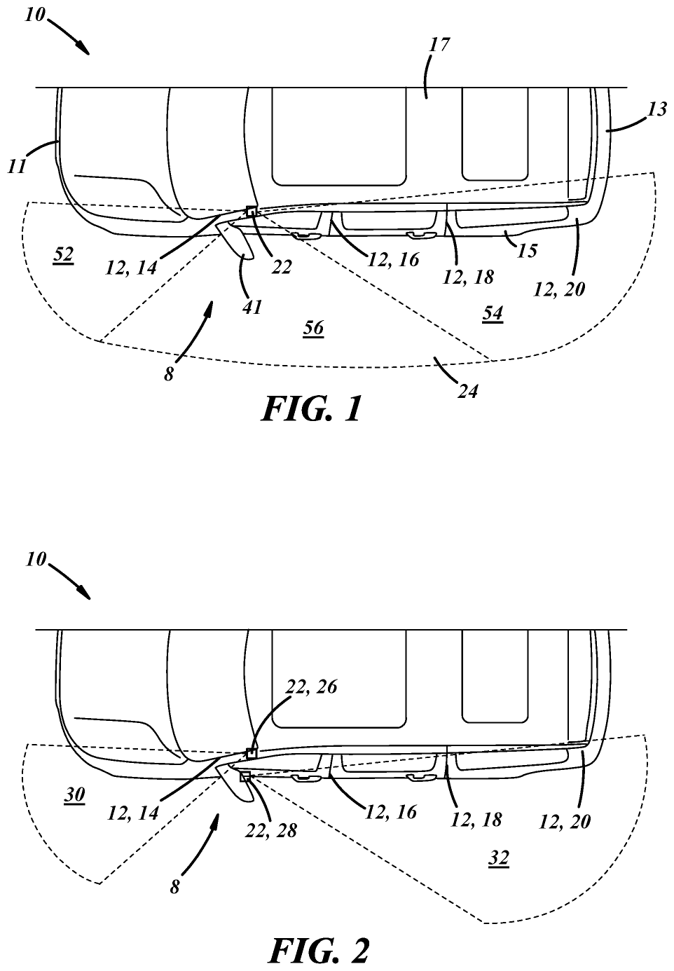

Referring in more detail to the drawings, FIGS. 1-5 show a display system 8 for a vehicle 10. As shown in FIG. 1, the vehicle 10 has a front end 11, a rear end 13, a right side (not shown) and an opposite left side 15. A frame includes a floor defining a bottom of an interior of the vehicle 10, a roof 17 an inner surface of which defines a top of the interior of the vehicle 10, and pillars 12 and other support members extending between the floor and the roof. The frame supports doors and windows, and mechanical and electrical systems of the vehicle 10.

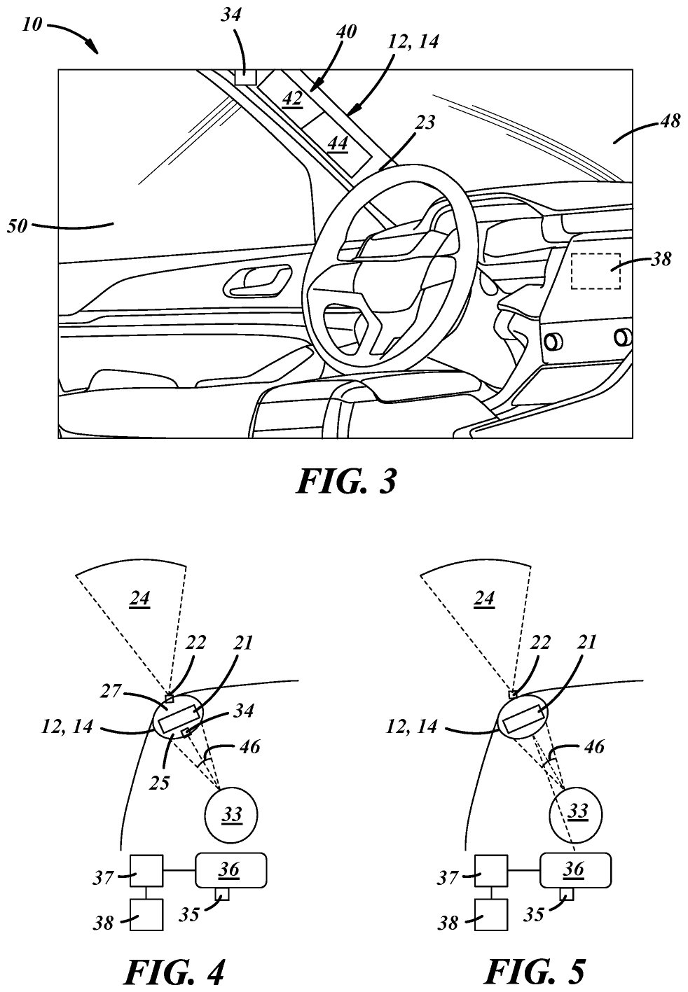

The pillars 12 extend from the floor of the vehicle 10 and may support the roof, doors, windows, windshield, among other vehicle components. Pillars 12 may be spaced apart and located at multiple positions along the vehicle 10. As shown in FIGS. 1 and 2, pillars 12 at the front of the vehicle 10 are generally known as A-pillars 14, while pillars 12 further back towards the rear are known as B-pillars 16, and C-pillars 18 and D-pillars 20 are provided in some vehicles. As shown in FIG. 4, each pillar may include a structural member 21 that may be solid or hollow, may be composed of a structural material such as a metal or composite. The structural member 21 has an inward facing portion facing the interior of the vehicle 10 and an outward facing portion facing away from the interior of the vehicle 10. If the structural member 21 is hollow, vehicle accessories and any associated wiring may be housed or routed through the structural member. The inward facing portion may be covered with an interior trim piece 23 (FIG. 3) to match the fit and finish of the interior. Between the trim piece 23 and inward facing portion an inner gap 25 may be provided that is capable of housing various vehicle accessories and/or any associated wiring. The outward facing portion may define part of the vehicle's body or may be separate and covered by vehicle body panels or exterior trim pieces. An outer gap 27 capable of housing various vehicle accessories and/or any associated wiring may be present in the space between body panels and the outward facing portion.

Within the interior of the vehicle 10, one or more seats are mounted to the floor to support one or more vehicle occupants 33. Each seat 36 may have a seat bottom, a seatback pivotably coupled to the seat bottom, and a headrest mounted to a top portion of the seatback. In known manner, the seat bottom may be slidably movable towards the front of the vehicle 10 or towards the rear of the vehicle 10. The seatback may pivot relative to the seat bottom towards the front of the vehicle 10 or towards the rear of the vehicle 10. And the headrest may extend vertically or horizontally from the seatback to support the head of a vehicle occupant 33. Movement of seat components may be done manually or by one or more electric motors 35 controlled by buttons, switches, or a seat controller 37.

The seat controller 37 may include a processor capable of executing commands to adjust the positions of the seat 36 by actuating the electric motors 35. To actuate the motors 35, the seat controller 37 may have a user interface integrated with a vehicle infotainment system or other vehicle system. Furthermore, the seat controller 37 may be capable of tracking the position of the seat 36 and relaying seat position information to a controller 39 of a vehicle control system and/or other vehicle systems.

The display system 8 includes one or more cameras 22, each camera 22 having an input through which light enters, which may include a lens, a sensor and an output via which image data is provided from the camera. Light within a field of view of the camera enters the camera 22 through the input and lens. The size and scope of the field of view may vary based on lens dimensions and/or the size of an input opening of the camera 22. In some implementations a lens having a wide field of view, such as between 30 degrees and 360 degrees, and in some implementations from 45 to 200 degrees, may be preferred to include a larger portion of the area outward from the camera 22. In other embodiments a narrower field of view may be preferred to include a more specific area outward from the camera 22. As used herein, the term “captured field of view” 24 refers to the field of view of the camera 22.

As shown in FIGS. 1 and 2, one or more cameras 22 may be mounted on the vehicle 10 in any desired location(s). In at least some implementations, one or more cameras 22 is/are located so that the captured field of view 24 includes an area outward of a side of the vehicle 10. In at least some implementations, the captured field of view 24 includes an area outward of the A-pillar 14 that is blocked from direct viewing by a driver of the vehicle because of the location of the driver relative to the A-pillar 14. In some implementations, the captured field of view 24 of at least one camera 22 may include an area outward of the A-pillar 14 and including at least a portion of the area outward of the vehicle 10 between the rear end 13 and the A-pillar 14, which may be similar to the field of view provided by a traditional rear view side mirror 41 (FIG. 1) if provided on the vehicle 10. The camera(s) 22 captured field of view 24 can include an area outward of any portion of the vehicle 10, as desired, and more cameras may be utilized, as desired.

As shown in the embodiment of FIG. 1, a camera 22 mounted to the exterior of the vehicle has at least one captured field of view 24 that extends at least partially outward from an exterior of a vehicle 10. In this implementation the camera 22 has a wide field of view including area towards the front 11, rear 13 and side 15 of the vehicle 10. In another embodiment, as shown in FIG. 2, multiple cameras 22 may be mounted to the exterior of the vehicle 10. Here, a first camera 26 is mounted to the exterior of the pillar 12 (e.g. at least partially in the outer gap 27) and has a first captured field of view 30 extending outward from the pillar 12. A second camera 28 is mounted along the side of the vehicle 10 and has a second captured field of view 32 extending towards the rear of the vehicle 10 that includes at least a portion of an area outward of a side of the vehicle 10, allowing the vehicle occupant 33 to see a vehicle “blind spot” to the side and behind a vehicle occupant 33. A captured field of view 24 may also replicate the field of view of a rear-view side mirror 41, such that a side mirror is no longer necessary to include in the design of the vehicle 10. This would save manufacturing costs while also making a more aerodynamic, fuel efficient, and pedestrian-safe vehicle 10. In an embodiment shown in FIGS. 3 and 4, an interior camera 34 is mounted within the interior of the vehicle 10 and has a field of view at least partially facing the seat 36. The interior camera 34 is configured to detect a position of at least part of a vehicle occupant 33 such as the head or even the eyes and determine the position relative to one or more pillars 12.

The video or image output from the one or more camera(s) 22 is provided to one or more controllers 38 (shown in FIGS. 3 and 4) that is in communication with the camera(s) 22 by wired or wireless connection. The controller 38 is or has a processor arranged to control the output received from the cameras 22 and can process the video to, if desired, alter the size, scale, quality, zoom, contrast, color, brightness, and other video properties, and in at least some implementations can divide the captured field of view to enable separate display of portions of the captured field of view. The controller 38 may also be in communication with other vehicle accessories such as the seat controller 37, to receive vehicle information such as the seat position.

As shown in FIG. 3, to enable viewing of the camera images/video, a display 40 is mounted to a pillar 12 facing the interior of the vehicle 10. The display 40 may be mounted to any pillar 12 of the vehicle 10 as necessary for the intended application, The display 40 may substantially follow the shape of the pillar 12 and may be mounted flush with the trim or slightly below an outer surface or layer of the trim. In the example shown, the windshield 48 is on one side of the pillar, a window 50 of a vehicle door is on the other side of the pillar and the display is mounted on an inward facing surface of the interior trim piece of the pillar 12. The display may extend across the entire width of the pillar between the windshield 48 and window 50, or that portion of the pillar 12 that is visible by the occupant nearest the pillar 12, or part of the pillar 12 may be visible on one or both sides of the display 40 and between the display 40 and the windshield 48 and window 50. In some implementations, a layer of material, which may be thin and translucent or porous, for example, may be part of the interior trim for the pillar 12 and may at least partially cover the display 40 such that the display 40 is visible when illuminated but is less visible when not in use (i.e. less distinguishable from the pillar 12 or interior trim piece).

In at least some implementations, the display 40 may be a thin film transistor display, liquid crystal display, light emitting diode or other suitable display type. The display 40 is comprised of a number of strategically aligned independently operated color pixels and is in communication with the controller 38 and receives video from the controller 38. Thus, the display 40 is configurable to display multiple images subsequently. As shown in FIG. 3, the display may be configured to concurrently show multiple displayed fields of view, which may include a first displayed field of view 42 and a second displayed field of view 44 on separate portions of the display 40. In at least some implementations, the relative size, location and orientation on the display 40 of the first displayed field of view 42 and the second displayed field of view 44 on the display 40 is configurable by a vehicle occupant 33, such as may be done via suitable programs available through a vehicle infotainment system. In other implementations, more than two displayed fields of view may be concurrently shown on the display 40.

In at least some embodiments, the display 40 may be in communication with other vehicle systems such that vehicle information can be shown on the display 40. Vehicle information may include vehicle speed, vehicle fuel range, navigational information, audio information, or information regarding other vehicle functions. Vehicle information may be shown concurrently with one or more displayed fields of view and the orientation of the display 40 may be configurable by the vehicle occupant 33.

In at least some embodiments, the dimension of the captured field(s) of view may be predetermined such that the controller 38 always alters the camera(s) 22 field of view to create a displayed field of view with set boundaries. In other embodiments, the controller 38 may input real-time data relative to the position of one or more vehicle components, like seat 36, to adjust the boundaries of a displayed field of view as a function of the vehicle component data. As a vehicle occupant 33 moves within the vehicle interior, a viewing angle 46, of the vehicle occupant 33 relative to the display, changes. As shown in FIGS. 4 and 5, the viewing angle 46 represents the angle between a vehicle occupant's eyes and the pillar 12. The closer an occupant 33 is to the pillar 12 the more the vehicle occupant's field of view 46 is obscured by the pillar 12. To compensate for this, any captured field of view 24 that is intended to show to the vehicle occupant 33 the portion of the vehicle occupant's field of view that is obstructed by the pillar 12 is adjusted by the controller 38 as a function of the viewing angle 46. In this way, the display 40 provides to the viewer a more accurate depiction of the area behind the pillar that the pillar blocks from the occupant's viewing angle. The viewing angle 46 can be determined as a function of the width of the pillar 12 and the distance of the vehicle occupant's 33 eyes to the pillar 12.

A shown in FIG. 4, the interior camera 34 detects the position of at least part of the vehicle occupant 33, or a vehicle component associated with the occupant, such as the seat 36 and relative to the pillar 12. This position information is provided to the controller 38 which may adjust the portion of a captured field of view 24 that is displayed on the display 40, as noted. In addition to or instead of using camera 34 to detect occupant location, the seat position may be determined by the camera 34 or from data provided to the controller 38 from the seat controller 37. In this way, the controller 38 can use the seat position data to adjust the output from the camera 34 based on the approximate position of the vehicle occupant's 33 eyes such that a portion of the vehicle occupant's 33 field of view that is obscured by the pillar 12 is shown on the display 40.

The display system 8 can provide one or more displayed fields of view on a display 10 within the vehicle 10, and the display 40 may be provided on all or part of an interior facing surface of a pillar 12. The displayed fields of view may come from one or more cameras, as desired, and may comprise all or part of the captured field of view of such camera(s).

For example, in FIG. 1, a single camera may have a total captured field of view 24 that includes a first field of view 52, a second field of view 54 and a third field of view 56. In this example: a) the first field of view 52 is a portion of the total field of view 24 and includes all or part of an area outboard of the pillar 12 that is blocked from view of an occupant 33 by the pillar 12; b) the second field of view 54 is a portion of the total field of view 24 that is different than the first field of view 52 and includes all or part of an area to the side and behind the pillar 12 (e.g. a view looking toward the rear end 13 of the vehicle 10); and c) the third field of view 56 is a portion of the total field of view 24 and includes all or part of an area between the first and second fields of view 52, 54. In at least some implementations, the camera 22 may provide images or videos of the entire field of view 24 to the controller 38 and the controller may divide or crop the images or video to display only one of the fields of view 52, 54 or 56, or a portion thereof, or the controller 38 may provide different ones of the fields of view 52, 54, 56 to different portions of the display for simultaneous display of such fields of view. In the example of FIG. 2, the captured fields of view of the two cameras 26, 28 can be presented on the display 40 one at a time, or together, and the captures fields of view 30, 32 may be provided in whole or part by the controller 38 to the display 40. Additionally, the controller may provide other information (e.g. vehicle operating parameters like speed, location information, etc, as an overlay on a simultaneously displayed field of view, providing even more information to the driver via the display 40.

The display system 8 can provide camera images and other information on an interior surface of one or more pillars in the vehicle. While described in more detail with regard to a forward of A-pillar, displays can be provided on other pillars within the vehicle and may be viewed by occupants other than the driver, as desired. The displays on other pillars may show areas outside the vehicle that are blocked from view by occupants or other information (including videos or entertainment content, by way of a non-limiting example).

In order to perform the functions and desired processing set forth herein, as well as the computations therefore, the control system or controller 38 which may comprise or be part of a control system, may include, but is not limited to, one or more controller(s), processor(s), computer(s), DSP(s), memory, storage, register(s), timing, interrupt(s), communication interface(s), and input/output signal interfaces, and the like, as well as combinations comprising at least one of the foregoing. For example, the control system may include input signal processing and filtering to enable accurate sampling and conversion or acquisitions of such signals from communications interfaces and sensors. As used herein the terms controller or control system may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system/controller may be distributed among different vehicle modules, such as an infotainment control module, engine control module or unit, powertrain control module, transmission control module, and the like, if desired, and the memory and one or more processors may be one or both integrated into the vehicle 10 or remotely located and wirelessly communicated to the vehicle 10, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

What is claimed is:

1. A vehicle display system, comprising:
at least one camera having at least one captured field of view that extends at least partially outward from an exterior of a vehicle;
a display mounted on a pillar within an interior of the vehicle;
a controller coupled to the camera and the display to show a displayed field of view on the display, wherein the displayed field of view is at least part of the at least one captured field of view and wherein the controller is configured to provide more than one displayed field of view concurrently from the at least one camera to the display.

2. The system of claim 1, wherein the controller and display are configured to show multiple displayed fields of view from the at least one camera concurrently on separate portions of the display.

3. The system of claim 2, wherein the at least one captured field of view includes a first captured field of view extending outward from the pillar and a second captured field of view extending towards the rear of the vehicle that includes at least a portion of an area outward of a side of the vehicle.

4. The system of claim 3, wherein the first captured field of view and the second captured field of view are shown concurrently on separate portions of the display.

5. The system of claim 4, wherein the orientation of the first captured field of view and the second captured field of view on the display is configurable by a vehicle occupant.

6. The system of claim 2, wherein the at least one camera includes a first camera having a first captured field of view extending outward from the pillar and a second camera having a second captured field of view extending towards the rear of the vehicle that includes at least a portion of an area outward of a side of the vehicle.

7. The system of claim 6, wherein at least parts of the first captured field of view and the second captured field of view are shown concurrently on separate portions of the display.

8. The system of claim 7, wherein the orientation of the at least parts of the first captured field of view and the second captured field of view on the display is configurable by a vehicle occupant.

9. A vehicle display system, comprising:
a camera having a first captured field of view that extends at least partially outward from an exterior of a vehicle;
a display mounted on a pillar within an interior of the vehicle; and
a controller coupled to the camera and the display to a first displayed field of view on the display, wherein the first displayed field of view is at least part of the first captured field of view and the first displayed field of view is adjusted as a function of a viewing angle.

10. The system of claim 9, further comprising a seat, wherein the viewing angle is determined as a function of a position of the seat of the vehicle.

11. The system of claim 10, wherein the viewing angle considers the position of the seat relative to the pillar to approximate the position of a vehicle occupant.

12. The system of claim 11, wherein the controller adjusts the output from the camera based on the approximated position of the vehicle occupant such that a portion of a vehicle occupant field of view that is obscured by the pillar is shown on the display.

13. The system of claim 12, further comprising a second camera coupled to the controller and the display, and the second camera having a second captured field of view wherein the controller is configured to show on the display a second displayed field of view that includes at least part of the second captured field of view.

14. The system of claim 13, wherein the first displayed field of view and second displayed field of view are shown concurrently on separate portions of the display.

15. The system of claim 14, wherein the orientation of the first displayed field of view and the second displayed field of view on the display is configurable by a vehicle occupant.

16. The system of claim 9, further comprising an interior camera facing the interior of the vehicle, wherein the interior camera is configured to detect a position of at least part of a vehicle occupant relative to the pillar.

17. The system of claim 16, wherein the viewing angle is determined as a function of the position of the vehicle occupant relative to the pillar.

18. The system of claim 17, wherein the controller adjusts the first displayed field of view to include an area that is outboard of the pillar relative to the occupant and the viewing angle, wherein the area that is outboard of the pillar is obscured by the pillar from direct viewing by the occupant.

19. The system of claim 18, further comprising a second camera having a second captured field of view and a second displayed field of view wherein the first displayed field of view and the second displayed field of view are shown concurrently on separate portions of the display.

20. The system of claim 19, wherein the orientation of the first displayed field of view and the second displayed field of view on the display is configurable by a vehicle occupant.
